(19) United States
(12) Patent Application Publication
(10) Pub. No.: US 2026/0300854 A1
(43) Pub. Date: Oct. 1, 2026

(54) ADAPTIVE TASK MANAGEMENT

(71) Applicant: Citigroup Inc., New York, NY (US)

(72) Inventors: Krishnat Narayan Molawade, Kharadi (IN); Seema Almas Yunus Shaikh, Kharadi (IN); Chandan Kumar, Kharadi (IN)

(21) Appl. No.: 19/090,200

(22) Filed: Mar. 25, 2025

(51) Int. Cl. G06Q 10/0631

(52) U.S. Cl. CPC G06Q 10/06311

(57) ABSTRACT

Metadata corresponding to a task is provided as input to a machine learning model that is to identify one or more patterns in the metadata indicative of resource misallocation and other factors that may decrease efficiency of performance of the task. A recommendation to set a task parameter is output from the machine learning model. The recommendation is provided to a client device as an indication that may be selected or otherwise confirmed from the client device so as to set the task parameter according to the recommendation.

### BACKGROUND

Managing task performance can be complex. In certain circumstances, such task management may be hindered by fixed timelines and/or after-the-fact responses to unforeseen changes in conditions that may affect the task performance (e.g., competitive factors, demand shifts, group interactions, etc.). For instance, a group collectively performing a task (e.g., a group of users participating in task performance from a plurality of client devices) may be slow to deviate from a static procedure that does not factor in such changing conditions. Efficiency of task performance may be decreased as a result of not identifying and adjusting for changing conditions with greater immediacy.

### BRIEF DESCRIPTION OF THE DRAWINGS

Various embodiments and techniques will be described with reference to the drawings, in which:

FIG. 1 illustrates an example of a computing system implementing a task managing system in accordance with at least one embodiment;

FIG. 2 illustrates an example of a flowchart of a process for using a task managing system to adaptively manage a task in accordance with at least one embodiment;

FIG. 3 illustrates an example of a flowchart of a process for using a machine learning model to generate a recommendation for a task managing system in accordance with at least one embodiment;

FIG. 4 illustrates an example of a process flow diagram of a task managing system in accordance with at least one embodiment;

FIG. 5 illustrates an example of a computing device in which various embodiments can be implemented in accordance with at least one embodiment; and

FIG. 6 illustrates an example of a software stack of a programming platform in accordance with at least one embodiment.

### DETAILED DESCRIPTION

Techniques and systems described and suggested herein relate to adaptive task management. In at least one embodiment, a computer-implemented method for adaptively managing a task within a task managing system may include: obtaining, from one or more data sources, metadata corresponding to the task, the metadata including information corresponding to task execution and group interactions; providing the metadata as input to a machine learning model that is to identify one or more patterns in the metadata indicative of resource misallocation; obtaining, as output from the machine learning model, a recommendation to adjust a task parameter based, at least in part, on an identified resource misallocation in the metadata and an effect of the identified resource misallocation on an efficiency of the task execution; providing the recommendation to a client device communicatively coupled to the task managing system to cause the client device to present an indication on the client device to indicate the recommendation; and responsive to receiving a user selection from the client device, adjusting the task parameter associated with the recommendation to output an adjusted task parameter.

In at least one embodiment, a system may include: one or more processors; and one or more non-transitory computer-readable media including computer-executable instructions recorded thereon that, if executed by the one or more processors, cause the system to: identify, from one or more data sources, metadata from information, shared among a plurality of client devices, corresponding to task performance; provide the metadata as input to a machine learning model that is to generate a recommendation to update a task parameter based, at least in part, on one or more patterns in the metadata indicative of use of the task parameter that is lowering an efficiency of the task performance; obtain, as output from the machine learning model, the recommendation; present, from a first client device, an indication to increase the efficiency of the task performance based, at least in part, on the recommendation; and responsive to receiving a selection of the indication from the first client device, update the task parameter according to the recommendation.

In at least one embodiment, one or more non-transitory computer-readable storage media may store computer-executable instructions that, if executed by one or more processors of a computer system, cause the computer system to at least: extract metadata from information stored in one or more data sources, the information usable in performance of a task; pass the metadata through a machine learning model that is to identify one or more patterns within the metadata indicative of lower than a threshold efficiency of the performance of the task; obtain, from the machine learning model, a recommendation to set a task parameter; provide the recommendation to one or more client devices as a performance indicator; and responsive to receiving a selection of the performance indicator from at least one of the one or more client devices, set the task parameter.

These, as well as other aspects, advantages, and alternatives will become apparent to those of ordinary skill in the art by reading the following detailed description, with reference where appropriate to the accompanying drawings. Further, it should be understood that descriptions and figures provided herein are intended to illustrate the invention by way of example only and, as such, that numerous variations are possible.

For example, the following description relates to various embodiments of systems and methods for adaptively managing tasks by applying a machine learning model to generate recommendations that indicate improvements to efficient task performance. Because the task performance may be affected by changing conditions (e.g., adjustments to group dynamics), it is recognized in embodiments described herein that a correlation may exist between how efficiently the task is performed and how quickly the changing conditions addressed. In such circumstances, for example, the efficiency of the task performance may be improved if the changing conditions are more readily recognized and utilized to adjust the task performance. It may therefore be desirable for task managing systems to more immediately identify changing conditions.

In at least one embodiment, metadata may be systematically collected about a task to be performed and the metadata may be input into a machine learning model or other artificial intelligence algorithm (e.g., a large language model implementing natural language processing). In at least one embodiment, the machine learning model may be trained or otherwise configured to determine whether efficiency of the performance of the task may be improved and to recommend specific such improvements in this regard.

In an exemplary embodiment, new information about a task, such as indications of changing conditions or other metadata, may be input into a machine learning model. The machine learning model may identify potential adjustments to the task or updates to one or more task parameters to enhance efficiency and/or adjust expectations (e.g., identifying additional or alternative actions, reducing a number of actions to take, changing a timeline for performing the task, competitor analysis on similar use cases, etc.). In this way, more proactive identification of changing conditions or potential issues may be implemented, reducing manual effort and delays associated with addressing such changing conditions or potential issues.

Techniques described and suggested in the present disclosure improve the field of computing, especially the field of adaptive task management, by dynamically updating task parameters based, at least in part, on patterns, in information corresponding to task execution and group interactions, indicative of resource misallocation, group morale, competitor analysis, and/or potential risk. Additionally, techniques described and suggested in the present disclosure improve the efficiency of computing systems by providing for such information and/or task parameters to be automatically updated in a feedback loop, e.g., responsive to changes in task performance over time. Moreover, techniques described and suggested in the present disclosure are necessarily rooted in computer technology in order to overcome problems specifically arising with real-time pattern identification in information pertaining to task performance by standardizing the information for use in predictive models and utilizing predicted inefficiencies to iteratively update the task performance.

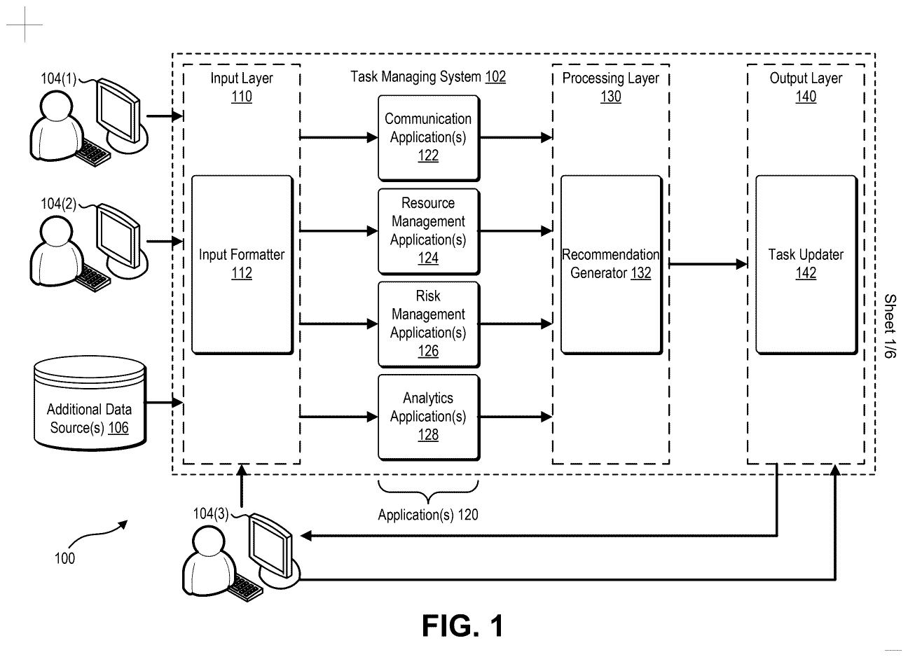

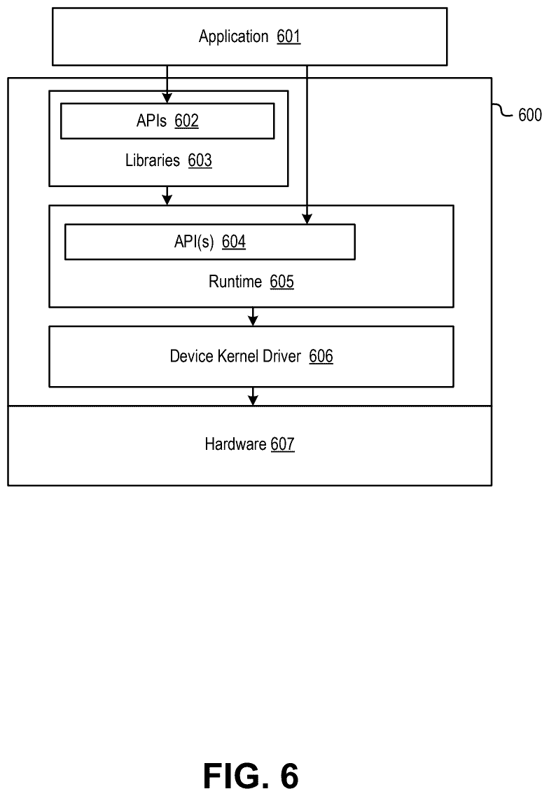

Referring now to FIG. 1, a computing system 100 that implements, stores, or otherwise uses a task managing system 102 is shown, according to at least one embodiment. In an exemplary embodiment, the task managing system 102 (also referred to herein, with or without other components of the computing system 100, as a task management platform 102) may include one or more layers (e.g., 110, 130, and 140) and one or more applications 120 that perform functions and/or modularized operations. For example, an input layer 110 may receive and format one or more inputs indicating information about a task, the one or more applications 120 may extract metadata about the task from the one or more (formatted) inputs, a processing layer 130 may utilize a machine learning model to identify one or more patterns in the metadata and generate a recommendation, and an output layer 140 may update the task responsive to the recommendation being confirmed by a task manager. In at least one embodiment, one or more functions performable by the task managing system 102 may be exposed by one or more application programming interfaces (APIs), such as one or more APIs included in software stack 600 of FIG. 6.

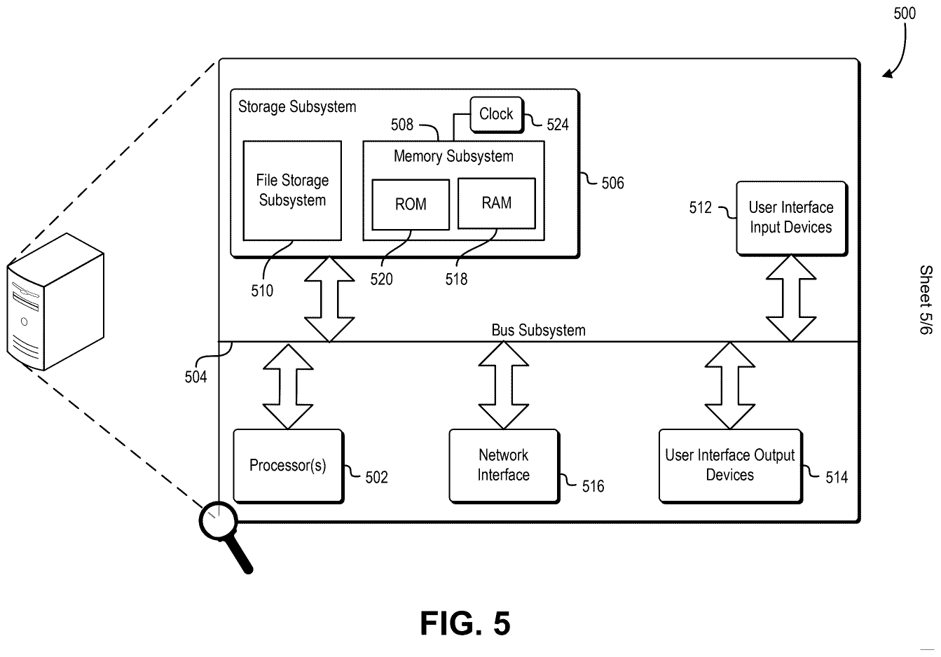

In some embodiments, a plurality of client devices 104 (e.g., a first client device 104(1), a second client device 104(2), a third client device 104(3), and so on) may share information among one another, such as pertaining to a task to be performed. For instance, each of the plurality of client devices 104 may be operated by a user in a group of users that are to collectively perform a task. The task may include, but is not limited to, a commercial objective, an engagement campaign, versioning software, regulation compliance (e.g., in a healthcare setting), and so on. In certain embodiments, the plurality of client devices 104 may directly communicate (e.g., share information) with one another. In additional or alternative embodiments, the plurality of client devices 104 may communicate (e.g., share information) with one another via the task managing system 102. Accordingly, in some such embodiments, the plurality of client devices 104 may be communicably coupled to the task managing system 102, e.g., via a network in communication with a server storing the task managing system 102 in non-transitory memory. In an exemplary embodiment, one or more of the plurality of client devices 104 may be configured as a computing device, such as computing device 500 of FIG. 5. In some embodiments, additional information, such as pertaining to the task to be performed, may be obtained by the task managing system 102 and/or the plurality of client devices 104 from one or more additional data sources 106. In an exemplary embodiment, the one or more additional data sources 106 may include one or more non-transitory data stores, such as one or more non-transitory computer-readable storage media, communicably coupled to the task managing system 102 and/or the plurality of client devices 104.

In some embodiments, the task managing system 102 may include the input layer 110. In an exemplary embodiment, the input layer 110 may include or otherwise implement one or more functions to process or otherwise utilize one or more inputs, such as from one or more of the plurality of client devices 104 and/or the one or more additional data sources 106. As an example, the input layer 110 may include an input formatter 112 that is to implement software to format, parse, or otherwise process one or more inputs received by the task managing system 102. The one or more inputs may include, but are not limited to, information usable in performance of a task. In some embodiments, the one or more inputs may be continuously received (e.g., in real-time, as generated by the plurality of client devices 104 and/or the one or more additional data sources 106) by the task managing system 102. In additional or alternative embodiments, the one or more inputs may be received periodically (e.g., at regular intervals) by the task managing system 102. In additional or alternative embodiments, the one or more inputs may be received intermittently (e.g., at irregular intervals) by the task managing system 102. In some embodiments, the input formatter 112 may function as a bus that is to distribute one or more outputs of the input formatter 112 to one or more other modules, applications, or layers of the task managing system 102, such as to the one or more applications 120. In at least one embodiment, the input formatter 112 may perform one or more processes such as those described herein by including or otherwise encoding instructions that cause performance of or otherwise can be utilized to perform the one or more processes.

In some embodiments, the task managing system 102 may include the one or more applications 120. In an exemplary embodiment, the one or more applications 120 may include or otherwise implement one or more functions to process or otherwise utilize one or more inputs, such as output by the input layer 110, to generate metadata. For instance, the one or more applications 120 may extract, identify, or otherwise obtain metadata from one or more formatted inputs output by the input formatter 112. The metadata may include, but is not limited to, one or more indicators of information pertaining to a task to be performed, such as task timelines, dependencies, and/or communication logs including one or more indicators of group morale, group feedback, and/or demand shifts. As an example, the one or more applications 120 may include one or more communication applications 122 that are usable by the plurality of client devices 104 to pass one or more communications (e.g., textual, user-facing information) between the plurality of client devices 104. As an additional or alternative example, the one or more applications 120 may include one or more resource management applications 124 that are usable by the plurality of client devices 104 to generate schedules and timelines, discretize tasks, and the like. As an additional or alternative example, the one or more applications 120 may include one or more risk management applications 126 that are usable by the plurality of client devices 104 to assess risk and/or estimate efficiency of current task performance and/or updates to be implemented in performance of the task (e.g., via real-time code analysis and/or historic bug patterns). As an additional or alternative example, the one or more applications 120 may include one or more analytics applications 128 that are usable by the plurality of client devices 104 to analyze external factors, such as demand shifts, competitor activity, and the like. In some embodiments, any one or more of the one or more applications 120 may implement a machine learning (ML) model or other artificial intelligence (AI) algorithm to extract at least a portion of the metadata from the one or more formatted inputs. In at least one embodiment, each of the one or more applications 120 may perform one or more processes such as those described herein by including or otherwise encoding instructions that cause performance of or otherwise can be utilized to perform the one or more processes.

In some embodiments, the task managing system 102 may include the processing layer 130. In an exemplary embodiment, the processing layer 130 may include or otherwise implement one or more functions to process or otherwise utilize one or more inputs, such as the metadata output by the one or more applications 120, to generate one or more predictions. As an example, the processing layer 130 may include a recommendation generator 132 that is to implement software to identify one or more patterns in the metadata to generate one or more recommendations. For instance, the recommendation generator 132 may implement a ML model or other AI algorithm, such as a large language model implementing natural language processing, that is trained or otherwise configured to identify the one or more patterns in the metadata and generate the one or more recommendations based, at least in part, on the one or more identified patterns. In some embodiments, the one or more patterns may be indicative of inefficiencies brought about by values of one or more task parameters to be used to perform a task. Accordingly, in certain such embodiments, the one or more recommendations may include a recommendation to update a task parameter of the one or more task parameters. In at least one embodiment, the recommendation generator 132 may perform one or more processes such as those described herein by including or otherwise encoding instructions that cause performance of or otherwise can be utilized to perform the one or more processes.

In some embodiments, the task managing system 102 may include the output layer 140. In an exemplary embodiment, the output layer 140 may include or otherwise implement one or more functions to process or otherwise utilize one or more inputs, such as the one or more recommendations output by the processing layer 130, to update one or more tasks to be performed. As an example, the output layer 140 may include a task updater 142 that is to implement software to confirm one or more recommendations generated by the recommendation generator 132 and update one or more task parameters based, at least in part, on the one or more confirmed recommendations. For instance, the task updater 142 may request confirmation of the one or more recommendations from one of the plurality of client devices 104 designated as a task manager (e.g., the third client device 104(3)). In an exemplary embodiment, the task updater 142 may cause the task manager to present an indication in a user interface thereon to indicate one or more recommendations to be confirmed and/or a level of severity of whether to confirm the one or more recommendations. In such an embodiment, upon confirmation being selected at the user interface, an indication may be transmitted back to the task updater 142 that the one or more recommendations have been confirmed. In an exemplary embodiment, the one or more confirmed recommendations may be utilized by the task updater 142 to update a task parameter corresponding to the task to be performed. For example, the task updater 142 may utilize the one or more confirmed recommendations to provide an instruction to update the task parameter. In at least one embodiment, the task updater 142 may perform one or more processes such as those described herein by including or otherwise encoding instructions that cause performance of or otherwise can be utilized to perform the one or more processes.

In some embodiments, an indication that a task has been updated may be generated by the task managing system 102 to be transmitted to the plurality of client devices 104. In certain such embodiments, a feedback loop may thereby be established between the task managing system 102 and the plurality of client devices 104. For instance, the plurality of client devices 104 may share information among one another, such as pertaining to the task updated according to the indication, at least a portion of the information being provided back to the task managing system 102, e.g., to be used by the task managing system 102 to generate one or more additional recommendations to further update the task. In an exemplary embodiment, the feedback loop may be used to adaptively update the task until the task is completed and/or a stop condition is reached (e.g., a threshold number of recommendations are not confirmed, the task manager requests no further recommendations be generated, a quality metric of the recommendations being generated falls beneath a threshold, etc.).

In at least one embodiment, the task managing system 102 may utilize a ML model or other AI algorithm (e.g., implemented on the recommendation generator 132 and/or the one or more applications 120) to perform various task management objectives or other functions. In some embodiments, the task managing system 102 may gather or otherwise obtain initial metadata (e.g., via the one or more applications 120 extracting metadata from one or more inputs formatted by the input formatter 112) including task timelines, group progress metrics (such as task completion rates), task dependencies, task priorities, communication logs (such as emails, chat logs, or other messages), sentiment analysis data, real-time code analysis data, and/or historical bugs and risk patterns. In an exemplary embodiment, the task managing system 102 may dynamically adjust task timelines based, at least in part, on real-time progress and team availability identified from the metadata (e.g., group progress metrics, task timelines, and task dependencies may be used to analyze group productivity, adjust timelines, and update schedules). In an additional or alternative embodiment, the task managing system 102 may use sentiment analysis to identify and address group stress or fatigue (e.g., communication logs and sentiment analysis data may be used to identify stress patterns and propose actionable changes). In an additional or alternative embodiment, the task managing system 102 may unsure seamless communication across and among various groups performing a task (e.g., communication logs, task dependencies, and task priorities may be used to generate automated updates and reminders and transmit real-time notifications for changes in task priorities or dependencies). In an additional or alternative embodiment, the task managing system 102 may detect and address potential risks prior to escalation (e.g., real-time code analysis data and historical bug and risk patterns may be used to analyze code quality, identify high-risk sections of code, and generate group notifications).

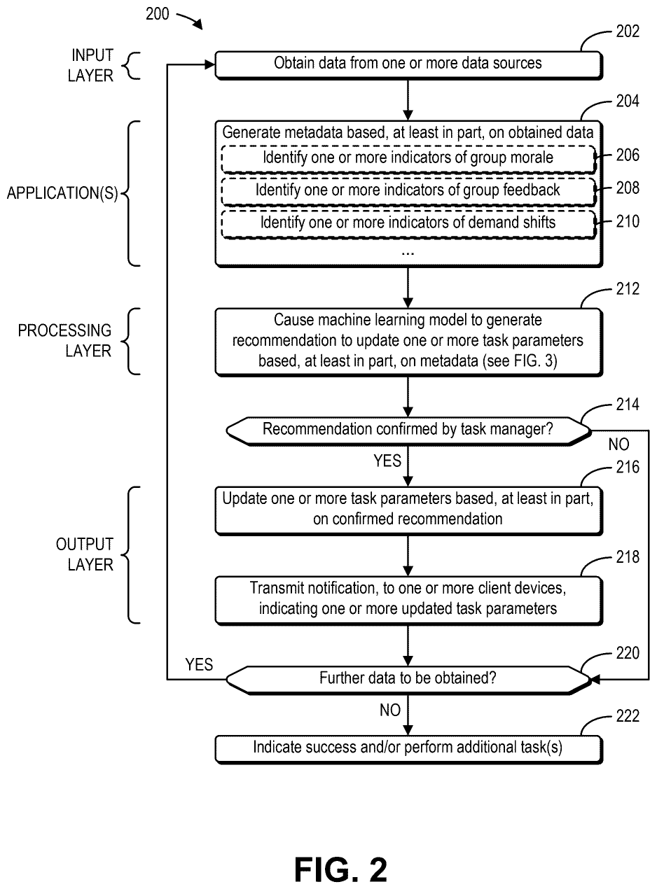

Referring now to FIG. 2, a flowchart of a method 200 for using a task managing system to adaptively manage a task is shown, according to at least one embodiment. In at least one embodiment, the method 200 may be implemented by performing computer-executable instructions, stored in non-transitory memory, to cause one or more processors of a computing system, such as the computing system 100 of FIG. 1, to adaptively manage the task. Accordingly, in certain such embodiments, the task managing system may be implemented as the task managing system 102 of FIG. 1. In at least one embodiment, one or more functions performable during the method 200 may be exposed by one or more application programming interfaces (APIs), such as one or more APIs included in software stack 600 of FIG. 6.

In some embodiments, the method 200, or portion(s) thereof, may be implemented as executable instructions stored in non-transitory memory of a computing device, such as included in a computing system (e.g., the computing system 100 of FIG. 1). However, though the method 200 are described herein, by way of example, as an ordered sequence of steps, embodiments of methods for using a task managing system to adaptively manage a task are not limited to the description of the method 200. For instance, in certain embodiments, additional or alternative sequences of steps may be implemented, e.g., as executable instructions on such a computing device, and performed, where individual steps discussed with reference to the method 200 may be added, removed, substituted, modified, or interchanged.

At block 202, the method 200 may include obtaining data from one or more data sources, according to at least one embodiment. In some embodiments, the one or more data sources may include one or more client devices and/or data stores. In an exemplary embodiment, the data includes information, shared among the plurality of client devices, usable in performance of a task or otherwise corresponding to task performance. In certain such embodiments, the data may be obtained from one or more task management applications (e.g., software to perform one or more particular task management functions implemented on the plurality of client devices, such as a project management application, a group collaboration application, a human resources platform, a threat detection platform, and the like). In certain such embodiments, the data may be obtained from a ML model (e.g., implemented on the plurality of client devices) to select, from information provided to the ML model, the information usable in the performance of the task or otherwise corresponding to task performance. In an exemplary embodiment, a task managing system may include or otherwise implement software to perform one or more functions to obtain the data in an input layer of the task managing system (e.g., the input layer 110 of FIG. 1). The task managing system may, in such an embodiment, obtain the data continuously (e.g., in real-time, as the data is generated) and/or at (regular or irregular) intervals.

At block 204, the method 200 may include generating metadata based, at least in part, on the obtained data, according to at least one embodiment. In an exemplary embodiment, the metadata corresponds to the task to be performed. Accordingly, in such an embodiment, the metadata may include information corresponding to task execution and group interactions. As an example, at block 206, the method 200 may include identifying one or more indicators of group morale (e.g., from the information corresponding to the task execution and the group interactions). As an additional or alternative example, at block 208, the method 200 may include identifying one or more indicators of group feedback (e.g., from the information corresponding to the task execution and the group interactions). As an additional or alternative example, at block 210, the method 200 may include identifying one or more indicators of demand shifts or other market trends (e.g., from the information corresponding to the task execution and the group interactions). In an exemplary embodiment, a task managing system may include or otherwise implement software to perform one or more functions to generate the metadata in one or more applications of the task managing system (e.g., the one or more applications 120 of FIG. 1).

At block 212, the method 200 may include causing a ML model to generate a recommendation to update, set, or otherwise adjust one or more task parameters based, at least in part, on the metadata (e.g., passed through the ML model), according to at least one embodiment. In an exemplary embodiment, the ML model may be trained or otherwise configured to identify one or more patterns in the metadata indicative of resource misallocation and/or lower than a threshold efficiency of task performance. In one such embodiment, the one or more patterns may be semantic connections among the metadata that are usable to generate the recommendation. In an exemplary embodiment, the ML model is a large language model implementing natural language processing. For example, the recommendation may include a textual recommendation to improve or otherwise increase the efficiency of task execution (e.g., to be greater than the threshold efficiency), e.g., a textual recommendation for mitigating a predicted effect of the identified resource misallocation via an update or other such adjustment of the one or more task parameters. In an exemplary embodiment, a task managing system may include or otherwise implement software to perform one or more functions to cause the ML model to generate the recommendation to update the one or more task parameters in a processing layer of the task managing system (e.g., the processing layer 130 of FIG. 1).

At block 214, the method 200 may include inferring whether the recommendation has been confirmed by a task manager (e.g., a client device of the plurality of client devices specified as the task manager), according to at least one embodiment. For instance, if it is inferred that the recommendation has not been confirmed by the task manager, the one or more task parameters may not be updated. In such a case, a determination may be made (e.g., at block 220) whether further data is to be obtained.

At block 216, the method 200 may include updating, setting, or otherwise adjusting the one or more task parameters based, at least in part, on the confirmed recommendation, according to at least one embodiment. For instance, the one or more task parameters may be updated, set, or otherwise adjusted if it is inferred that the recommendation has been confirmed by the task manager (e.g., at the block 214, such as if a selection has been received from the task manager). In an exemplary embodiment, the task managing system may provide an instruction to update, set, or otherwise adjust the one or more task parameters. In an exemplary embodiment, an application programming interface (API) of the task managing system may be performed to update, set, or otherwise adjust the one or more task parameters. In an exemplary embodiment, a task managing system may include or otherwise implement software to perform one or more functions to update the one or more task parameters in an output layer of the task managing system (e.g., the output layer 140 of FIG. 1).

At block 218, the method 200 may include transmitting a notification, to one or more client devices (e.g., of the plurality of client devices), indicating the one or more adjusted task parameters, according to at least one embodiment. In an exemplary embodiment, a task managing system may include or otherwise implement software to perform one or more functions to transmit the notification indicating the one or more updated task parameters in an output layer of the task managing system (e.g., the output layer 140 of FIG. 1).

At the block 220, the method 200 may include inferring whether further data is to be obtained, according to at least one embodiment. For instance, if it is inferred that further data is to be obtained, the further data may be obtained from the one or more data sources (e.g., at the block 202) so as to generate updated metadata. Accordingly, in at least one embodiment, the metadata may be dynamically identified and passed through the ML model so as to generate recommendations to update, set, or otherwise adjust task parameters to increase the efficiency of the task performance (e.g., to greater than the threshold efficiency or a previous efficiency of the task performance). In an exemplary embodiment, if the updated metadata is indicative of greater than the threshold efficiency of the task performance, the ML model may instead generate a recommendation to maintain the one or more adjusted task parameters.

At block 222, the method 200 may include indicating success and/or performing one or more additional tasks, according to at least one embodiment. For instance, success may be indicated (e.g., if greater than threshold efficiency of the task performance is indicated) and/or the one or more additional tasks may be performed if it is inferred that no further data is to be obtained (e.g., at the block 220).

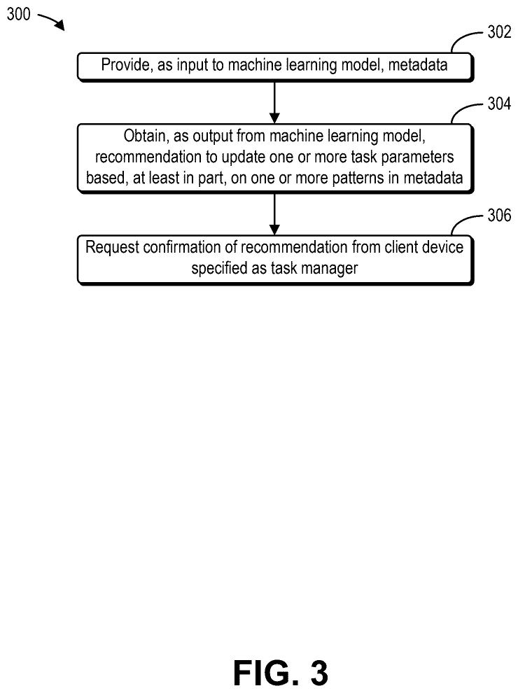

Referring now to FIG. 3, a flowchart of a method 300 for using a ML model to generate a recommendation for a task managing system is shown, according to at least one embodiment. In at least one embodiment, the method 300 may be implemented by performing computer-executable instructions, stored in non-transitory memory, to cause one or more processors of a computing system, such as the computing system 100 of FIG. 1, to generate the recommendation for the task managing system. Accordingly, in certain such embodiments, the task managing system may be implemented as the task managing system 102 of FIG. 1. In at least one embodiment, one or more functions performable during the method 300 may be exposed by one or more application programming interfaces (APIs), such as one or more APIs included in software stack 600 of FIG. 6.

In some embodiments, the method 300, or portion(s) thereof, may be implemented as executable instructions stored in non-transitory memory of a computing device, such as included in a computing system (e.g., the computing system 100 of FIG. 1). However, though the method 300 are described herein, by way of example, as an ordered sequence of steps, embodiments of methods for using a ML model to generate a recommendation are not limited to the description of the method 300. For instance, in certain embodiments, additional or alternative sequences of steps may be implemented, e.g., as executable instructions on such a computing device, and performed, where individual steps discussed with reference to the method 300 may be added, removed, substituted, modified, or interchanged. As an example, the method 300 may be performed as a portion of the method 200 of FIG. 2, such as in place of the block 212 as described in detail with reference to FIG. 2.

At block 302, the method 300 may include providing, as input to a ML model, metadata, according to at least one embodiment. In an exemplary embodiment, the metadata may be indicative of a task to be performed.

At block 304, the method 300 may include obtaining, as output from the ML model, a recommendation to update, set, or otherwise adjust one or more task parameters based, at least in part, on one or more patterns in the metadata, according to at least one embodiment. In an exemplary embodiment, the ML model may generate the recommendation based, at least in part, on an identified resource misallocation in the metadata and an effect of the identified resource misallocation on an efficiency of the task execution.

At block 306, the method 300 may include requesting confirmation of the recommendation from a client device (e.g., of a plurality of client devices communicably coupled to the task managing system) specified as a task manager, according to at least one embodiment. In an exemplary embodiment, the task manager is specified to approve, via selection of the indication via a user interface, updating, setting, or otherwise adjusting the one or more task parameters, the one or more adjusted task parameters to be communicated to remaining client devices of the plurality of client devices. In an exemplary embodiment, the task managing system may provide the recommendation to the task manager to cause the task manager to present or otherwise display an indication at the user interface to indicate the recommendation. In one such embodiment, the indication is to specify a severity of the identified resource misallocation. For example, the recommendation may be provided as a performance indicator (e.g., indicating lower than a threshold efficiency of performance of the task). In such an example, the performance indicator may be updated in real-time responsive to the metadata being periodically passed through the ML model. In one such embodiment, the indication is adaptively updated (e.g., at the user interface) as the one or more patterns are identified by the ML model. Accordingly, in one such embodiment, the indication is presented or otherwise displayed (e.g., at the user interface) immediately upon obtaining the recommendation as output from the ML model. In additional or alternative embodiments, the task managing system may provide the recommendation to the task manager as output by the ML model (e.g., in a format output by the ML model). In certain such embodiments, no indication may be generated and the task manager may instead confirm the recommendation in another manner, such as via a textual communication transmitted to the task managing system in response to the request for confirmation.

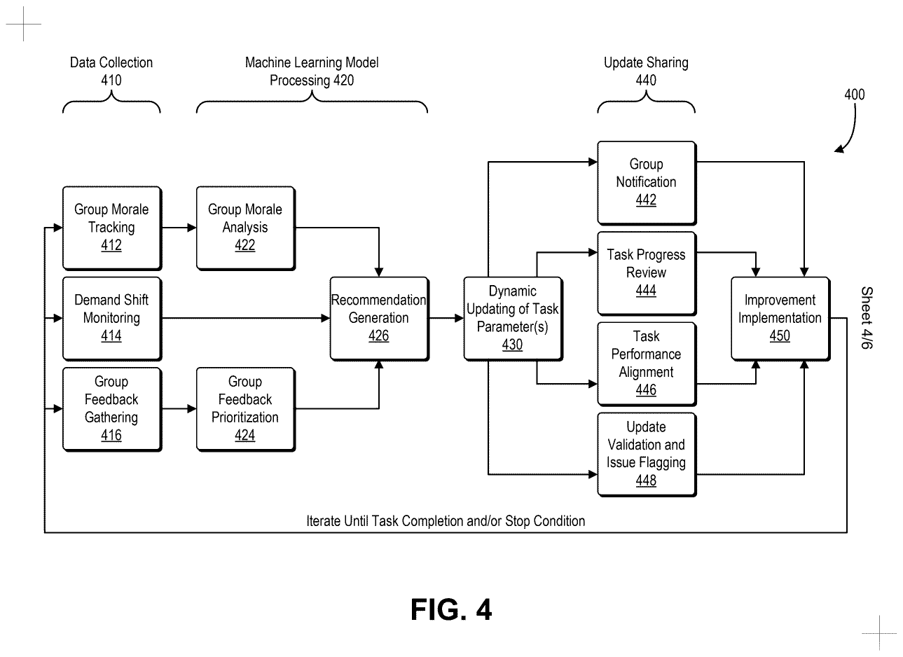

Referring now to FIG. 4, a process flow diagram of an exemplary use case of a task managing system 400 is shown, according to at least one embodiment. In at least one embodiment, the task managing system 400 may implement software to dynamically update one or more task parameters such as timelines or schedules to perform a task. In some embodiments, the task managing system 400 may be implemented, stored, or otherwise used by a computing system, such as the computing system 100 of FIG. 1. Accordingly, in certain such embodiments, the task managing system 400 may be implemented as the task managing system 102 of FIG. 1. In at least one embodiment, one or more functions performable by the task managing system 400 may be exposed by one or more application programming interfaces (APIs), such as one or more APIs included in software stack 600 of FIG. 6.

In some embodiments, the task managing system 400 performs data collection 410 to obtain initial data and/or metadata about a task to be performed. In such embodiments, the initial data and/or the metadata may be obtained continuously (e.g., in real-time). In additional or alternative embodiments, the initial data and/or the metadata may be obtained at intervals (e.g., regularly or irregularly). In certain embodiments, the task managing system 400 performing the data collection 410 may include the task managing system 400 performing group morale tracking 412, demand shift monitoring 414, and group feedback gathering 416.

In some embodiments, the task managing system 400 performs ML model processing 420 to extract additional metadata from the initial data and/or metadata and/or generate one or more recommendations. As an example, group morale obtained from the group morale tracking 412 may be analyzed 422 to be processed by a first ML model or other AI algorithm. As an additional or alternative example, group feedback obtained from the group feedback gathering 416 may be prioritized 424 by a second ML model or other AI algorithm. In certain embodiments, recommendation generation 426 may be performed by a third ML model or other AI algorithm.

In some embodiments, the task managing system 400 performs dynamic updating 430 of one or more task parameters of the task to be performed based, at least in part, on the one or more recommendations obtained from the recommendation generation 426.

In some embodiments, the task managing system 400 may perform update sharing 440 to notify or otherwise indicate to a plurality of client devices communicably coupled to the task managing system 400 that the one or more task parameters are to be updated according to the one or more recommendations. In certain embodiments, the task managing system 400 performing the update sharing 440 may include the task managing system 400 performing group notification 442 (e.g., notifying the plurality of client devices of the one or more task parameters to be updated), task progress review 444 (e.g., reviewing progress of the task after the one or more task parameters are updated), task performance alignment 446 (e.g., adjusting performance of the task based, at least in part, on the one or more updated task parameters), and update validation and issue flagging 448 (e.g., confirming whether or not the one or more updated task parameters are successfully realized).

In some embodiments, the task managing system 400 may perform improvement implementation 450 to retain the one or more updated task parameters during task performance. In certain embodiments, as task performance continues, the task managing system 400 may iterate the preceding function(s) until task completion and/or another stop condition is reached.

Referring now to FIG. 5, an illustrative, simplified block diagram of a computing device 500 is shown that may be used to practice at least one embodiment of the present disclosure. In various embodiments, the computing device 500 may include any appropriate device operable to send and/or receive requests, messages, or information over an appropriate network and convey information back to a user of the computing device 500. The computing device 500 may be used to implement any of the systems and methods illustrated and described herein, such as those described in detail with reference to FIGS. 1-4. For instance, systems and components described in relation to FIG. 5 can implement part or all of the computing system 100 of FIG. 1, the method 200 of FIG. 2, the method 300 of FIG. 3, and/or the task managing system 400 of FIG. 4. For example, the computing device 500 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 500 may be implemented as a hardware device, a virtual computer system, one or more programming modules executed on a computer system, and/or as another device configured with hardware and/or software to receive and respond to communications (e.g., web service API requests) over a network.

As shown in FIG. 5, the computing device 500 may include one or more processors 502 that, in certain embodiments, may communicate with and may be operatively coupled to a number of peripheral subsystems via a bus subsystem 504. In some embodiments, such peripheral subsystems may include a storage subsystem 506, including a memory subsystem 508 and a file/disk storage subsystem 510, one or more user interface input devices 512, one or more user interface output devices 514, and a network interface subsystem 516 (also referred to herein as a network interface 516). In certain embodiments, the storage subsystem 506 may be used for temporary or long-term storage of information.

In some embodiments, the bus subsystem 504 may provide a mechanism for enabling the various components and subsystems of computing device 500 to communicate with each other as intended. Although the bus subsystem 504 is shown schematically as a single bus, alternative embodiments of the bus subsystem 504 may utilize multiple buses. The network interface subsystem 516 may provide an interface to other computing devices and networks, such as client devices including, but not limited to, user computing devices communicably coupled to a task managing system, such as the task managing system 102 described in detail with reference to FIG. 1. The network interface subsystem 516 may serve as an interface for receiving data from to the computing device 500 and transmitting data to other systems from the computing device 500. In some embodiments, the bus subsystem 504 is utilized for communicating data such as user information, task metadata, queries, details, search terms, and so on. In an embodiment, the network interface subsystem 516 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UPnP), Network File System (NFS), Common Internet File System (CIFS), and other protocols.

The network (e.g., interfaced by the network interface 516), in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend, at least in part, upon the type of network and/or system selected. In an embodiment, a connection-oriented protocol may be used to communicate between network endpoints such that the connection-oriented protocol (sometimes referred to as a connection-based protocol) is capable of transmitting data in an ordered stream. In an embodiment, the connection-oriented protocol may be reliable or unreliable. As an example, the Transmission Control Protocol may be considered a reliable connection-oriented protocol. As another example, Asynchronous Transfer Mode (ATM) and Frame Relay may be considered unreliable connection-oriented protocols. In certain embodiments, connection-oriented protocols may be contrasted with packet-oriented protocols such as UDP that transmit packets without a guaranteed ordering. Certain protocols and components for communicating via such a network are well known and will not be discussed in detail. In an embodiment, communication via the network interface subsystem 516 may be implemented via wired and/or wireless connections or combinations thereof.

In some embodiments, the user interface input devices 512 may include one or more user input devices such as a keyboard; pointing devices such as an integrated mouse, trackball, touchpad, or graphics tablet; a scanner; a barcode scanner; a touch screen incorporated into a display; audio input devices such as voice recognition systems or microphones; and other types of input devices. In general, use of the term “input device” is intended to include all possible types of devices and mechanisms for inputting information to the computing device 500. In some embodiments, the one or more user interface output devices 514 may include a display subsystem, a printer, or non-visual displays such as audio output devices, etc. In some embodiments, the display subsystem may include a cathode ray tube (CRT), a flat-panel device such as a liquid crystal display (LCD), a light emitting diode (LED) display, or a projection or other display device. In general, use of the term “output device” is intended to include all possible types of devices and mechanisms for outputting information from the computing device 500. The one or more user interface output devices 514 may be used, for example, to present user interfaces to facilitate user interaction with applications performing processes described in detail with reference to FIGS. 1-4 and variations therein, when such interaction may be appropriate.

In some embodiments, the storage subsystem 506 may provide a computer-readable storage medium for storing the basic programming and data constructs that provide the functionality of at least one embodiment of the present disclosure. The applications (programs, code modules, instructions, etc.), when executed by one or more processors in some embodiments, may provide the functionality of one or more embodiments of the present disclosure and, in embodiments, are stored in the storage subsystem 506. Such application modules or instructions may be executed by the one or more processors 502. In various embodiments, the storage subsystem 506 may provide a repository for storing data used in accordance with the present disclosure. In some embodiments, the storage subsystem 506 may include a memory subsystem 508 and a file/disk storage subsystem 510.

In embodiments, the memory subsystem 508 may include a number of memories, such as a main random-access memory (RAM) 518 for storage of instructions and data during program execution and/or a read only memory (ROM) 520 in which fixed instructions may be stored. In some embodiments, the file/disk storage subsystem 510 may provide a non-transitory persistent (non-volatile) storage for program and data files and may include a hard disk drive, a floppy disk drive along with associated removable media, a Compact Disk Read Only Memory (CD-ROM) drive, an optical drive, removable media cartridges, or other like storage media.

In some embodiments, the computing device 500 may include at least one local clock 524. The at least one local clock 524, in some embodiments, may be a counter that represents the number of ticks that have transpired from a particular starting date and, in some embodiments, is located integrally within the computing device 500. In various embodiments, the at least one local clock 524 may be used to synchronize data transfers in various processors for the computing device 500 and the subsystems included therein at specific clock pulses, and may be used to coordinate synchronous operations between the computing device 500 and other systems in a data center, for example. In another embodiment, the at least local clock 524 may be a programmable interval timer.

The computing device 500 could be any one or more of a variety of types, including a portable computer device, a tablet computer, a workstation, or any other device described herein. In some embodiments, the computing device 500 may interface to or include another device that, in some embodiments, may be connected to the computing device 500 through one or more ports [e.g., a Universal Serial Bus (USB) port, a headphone jack, a Lightning connector, etc.]. In embodiments, such a device may include a port that accepts a fiber-optic connector. Accordingly, in some embodiments, such a device may convert optical signals to electrical signals that are transmitted through the port connecting the device to the computing device 500 for processing. Due to the ever-changing nature of computers and networks, the description of the computing device 500 depicted in FIG. 5 is intended only as a specific example for purposes of illustrating exemplary embodiments of the device. Various other configurations having more or fewer components than the computing device 500 depicted in FIG. 5 are possible.

In some embodiments, data may be stored in an additional data store (not depicted). In some examples, a “data store” may refer to any device or combination of devices capable of storing, accessing, and retrieving data, which may include any combination and number of data servers, databases, data storage devices, and data storage media, in any standard, distributed, virtual, or clustered system. A data store, in an embodiment, may communicate with block-level and/or object-level interfaces. The computing device 500 may include any appropriate hardware, software, and firmware for integrating with such a data store as desirable to execute aspects of one or more applications for the computing device 500 to handle some or all data access and logic for one or more applications. The data store, in an embodiment, may include several separate data tables, databases, data documents, dynamic data storage schemes, and/or other data storage mechanisms and media for storing data relating to a particular aspect of the present disclosure. In an embodiment, the computing device 500 may include a variety of data stores and other memory and storage media as discussed herein. Such data stores and other memory and storage media can reside in a variety of locations, such as on a storage medium local to (and/or resident in) one or more computers (e.g., the computing device 500) or remote from any or all of the computers across a network. In an embodiment, the information may reside in a storage-area network (SAN) familiar to those skilled in the art, and, similarly, any files usable for performing the functions attributed to the computers, servers, or other network devices may be stored locally and/or remotely, as appropriate.

In an embodiment, the computing device 500 may provide access to content including, but not limited to, text, graphics, audio, video, and/or other content that may be provided to a user in the form of Hypertext Markup Language (HTML), Extensible Markup Language (XML), JavaScript, Cascading Style Sheets (CSS), JavaScript Object Notation (JSON), and/or another appropriate language. The computing device 500 may provide the content in one or more forms including, but not limited to, forms that may be perceptible to the user audibly, visually, and/or through other senses. Handling of requests and responses, as well as delivery of content, in an embodiment, may be handled by the computing device 500 using PHP: Hypertext Preprocessor (PHP), Python, Ruby, Perl, Java, HTML, XML, JSON, and/or another appropriate language in various examples. In an embodiment, operations described as being performed by a single device may be performed collectively by multiple devices that form a distributed and/or virtual system.

In an embodiment, the computing device 500 may include an operating system that provides executable program instructions for the general administration and operation of the computing device 500 and may include a computer-readable storage medium (e.g., a hard disk, RAM, ROM, etc.) storing instructions that, if executed (e.g., as a result of being executed) by a processor of the computing device 500, cause or otherwise allow the computing device 500 to perform intended functions thereof (e.g., the functions may be performed as a result of one or more processors of the computing device 500 executing instructions stored on a computer-readable storage medium).

In an embodiment, the computing device 500 may operate as a web server that runs one or more of a variety of server or mid-tier applications, including Hypertext Transfer Protocol (HTTP) servers, FTP servers, Common Gateway Interface (CGI) servers, data servers, Java servers, Apache servers, and/or application servers. In an embodiment, computing device 500 may be capable of executing programs or scripts in response to requests from user devices, such as by executing one or more web applications that are implemented as one or more scripts or programs written in any programming language, such as Java®, C, C#or C++, or any scripting language, such as Ruby, PHP, Perl, Python, or TCL, as well as combinations thereof. In an embodiment, the computing device 500 may be capable of storing, retrieving, and accessing structured or unstructured data. In an embodiment, the computing device 500 may additionally or alternatively implement a database, such as one commercially available from Oracle®, Microsoft®, Sybase®, or IBM®, as well as open-source servers, such as MySQL, Postgres, SQLite, or MongoDB. In an embodiment, the database may include table-based servers, document-based servers, unstructured servers, relational servers, non-relational servers, or combinations of these and/or other database servers.

Referring now to FIG. 6, an example of a software stack 600 of a programming platform is shown. In at least one embodiment, a programming platform is a platform for utilizing hardware on a computing system to perform computational tasks. A programming platform may be accessible to software developers through libraries, compiler directives, and/or extensions to programming languages, in at least one embodiment.

In at least one embodiment, the software stack 600 may provide an execution environment for an application 601. In at least one embodiment, the application 601 may include any computer software capable of being launched on the software stack 600. In at least one embodiment, the application 601 may include, but is not limited to, an artificial intelligence (AI)/machine learning (ML) application, a high-performance computing (HPC) application, a virtual desktop infrastructure (VDI), or a data center workload. In at least one embodiment, the application 601 may include software to launch a task managing system, such as the task managing system 102 of FIG. 1 and/or the task managing system 400 of FIG. 4, on the software stack 600.

In at least one embodiment, the application 601 and the software stack 600 run on hardware 607. The hardware 607 may include one or more graphs processing units (GPUs), central processing units (CPUs), field-programmable gate arrays (FPGAs), AI engines, and/or other types of compute devices that support or are otherwise usable in a programming platform, in at least one embodiment. In at least one embodiment, the hardware 607 may include a host connected to one or more devices that may be accessed to perform computational tasks via API calls. A device within the hardware 607 may include, but is not limited to, a GPU, a FPGA, an AI engine, or other compute device (but may also include a CPU) and associated memory, as opposed to a host within the hardware 607 that may include, but is not limited to, a CPU (but may also include a compute device) and associated memory, in at least one embodiment.

In at least one embodiment, the software stack 600 may include, without limitation, a number of libraries 603, a runtime 605, and a device kernel driver 606. Each of the libraries 603 may include data and programming code that may be used by computer programs and utilized during software development, in at least one embodiment. In at least one embodiment, the libraries 603 may include, but are not limited to, pre-written code and subroutines, classes, values, type specifications, configuration data, documentation, help data, and/or message templates. In at least one embodiment, the libraries 603 may include functions that are optimized for execution on one or more types of devices. In at least one embodiment, the libraries 603 may include, but are not limited to, functions for performing mathematical, deep learning, and/or other types of operations on devices. In at least one embodiment, the libraries 603 may be associated with corresponding APIs 602, which may include one or more APIs, that expose functions implemented in the libraries 603.

In at least one embodiment, the application 601 may be written as source code that is compiled into executable code. Executable code of the application 601 may run, at least in part, on an execution environment provided by the software stack 600, in at least one embodiment. In at least one embodiment, during execution of the application 601, code may be reached that is to run on a device, as opposed to a host. In such a case, the runtime 605 may be called to load and launch requisite code on the device, in at least one embodiment. In at least one embodiment, the runtime 605 may include any technically feasible runtime system that is able to support execution of the application 601.

In at least one embodiment, the runtime 605 may be implemented as one or more runtime libraries associated with corresponding APIs, which are shown as the API(s) 604. One or more of such runtime libraries may include, without limitation, functions for memory management, execution control, device management, error handling, and/or synchronization, and the like, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 604 may be implemented in any technically feasible manner, in at least one embodiment. In at least one embodiment, one (or any number of) API(s) may expose a low-level set of functions for fine-grained control of a device, while another (or any number of) API(s) may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, one or more processors included in various processing systems described herein can perform, access, or otherwise use the software stack 600. For example, the computing device 500 of FIG. 5 can perform, use, call, or otherwise implement (e.g., through accessing a memory) one or more APIs included in the software stack 600. The one or more APIs may be implemented to adjust a task parameter of a task to be performed based, at least in part, on a recommendation generated by a machine learning model, as described in detail with reference to FIGS. 1, 2, and 4, as well as to cause the machine learning model to generate the recommendation, as described in detail with reference to FIG. 3.

In at least one embodiment, the device kernel driver 606 may be configured to facilitate communication with an underlying device. In at least one embodiment, the device kernel driver 606 may provide low-level functionalities upon which APIs, such as the API(s) 604, and/or other software rely. In at least one embodiment, the device kernel driver 606 may be configured to compile intermediate representation (IR) code into binary code at runtime. Alternatively, in at least one embodiment, device source code may be compiled into binary code offline, without utilizing the device kernel driver 606 to compile IR code at runtime.

Embodiments of the disclosure can be described in view of the following:

A system of one or more computers may be configured to perform particular operations or actions by virtue of having software, firmware, hardware, or a combination of them installed on the system that in operation causes or cause the system to perform the actions. One or more computer programs may be configured to perform the particular operations or actions by virtue of including instructions that, if executed by a data processing apparatus (e.g., one or more processors), cause the apparatus to perform the particular operations or actions. One general aspect includes a computer-implemented method for adaptively managing a task within a task managing system, the computer-implemented method including obtaining, from one or more data sources, metadata corresponding to the task, the metadata including information corresponding to task execution and group interactions. The computer-implemented method may also include providing the metadata as input to a machine learning model that is to identify one or more patterns in the metadata indicative of resource misallocation. The computer-implemented method may also include obtaining, as output from the machine learning model, a recommendation to adjust a task parameter based, at least in part, on an identified resource misallocation in the metadata and an effect of the identified resource misallocation on an efficiency of the task execution. The computer-implemented method may also include providing the recommendation to a client device communicatively coupled to the task managing system to cause the client device to present an indication on the client device to indicate the recommendation. The computer-implemented method may also include, responsive to receiving a user selection from the client device, adjusting the task parameter associated with the recommendation to output an adjusted task parameter. Other embodiments of this aspect include corresponding computer systems, apparatuses, and computer programs recorded on one or more computer storage devices, each configured to perform the particular operations or actions of the computer-implemented method.

Implementations may include one or more of the following features. The information corresponding to the task execution and the group interactions may include one or more indicators of group morale, group feedback, and/or demand shifts. The computer-implemented method may further include confirming that the adjusted task parameter improves the efficiency of the task execution by obtaining, from the one or more data sources, updated metadata corresponding to the task, providing the updated metadata as input to the machine learning model, and obtaining, as output from the machine learning model, a recommendation to maintain the adjusted task parameter based, at least in part, on the updated metadata. The indication may specify a severity of the identified resource misallocation. The indication may be adaptively updated as the one or more patterns are identified by the machine learning model. An application programming interface (API) of the task managing system may be performed to adjust the task parameter. The recommendation may include a textual recommendation for mitigating the effect of the identified resource misallocation on the efficiency of the task execution via an adjustment of the task parameter. Implementations of the described techniques may include hardware, a method or process, or computer software on a computer-accessible medium.

One general aspect includes a system which may include one or more processors and one or more non-transitory computer-readable media including computer-executable instructions recorded thereon that, as a result of execution by the one or more processors, may cause the system to identify, from one or more data sources, metadata from information, shared among a plurality of client devices, corresponding to task performance. The instructions may also cause the system to provide the metadata as input to a machine learning model that is to generate a recommendation to update a task parameter based, at least in part, on one or more patterns in the metadata indicative of use of the task parameter that is lowering an efficiency of the task performance. The instructions may also cause the system to obtain, as output from the machine learning model, the recommendation. The instructions may also cause the system to present, from a first client device, an indication to increase the efficiency of the task performance based, at least in part, on the recommendation. The instructions may also cause the system to, responsive to receiving a selection of the indication from the first client device, update the task parameter according to the recommendation. Other embodiments of this aspect include corresponding computer systems, apparatus, and computer programs recorded on one or more computer storage devices, each configured to perform the actions of the methods.

Implementations may include one or more of the following features. The metadata may be dynamically identified and passed through the machine learning model so as to generate recommendations to update task parameters to increase the efficiency of the task performance. The indication may be presented immediately upon obtaining the recommendation as output from the machine learning model. The first client device may be specified as a task manager that is to approve, via the selection of the indication, updating the task parameter to output an updated task parameter to be communicated to remaining client devices of the plurality of client devices. The instructions may also cause the system to cause an additional machine learning model to select, from information provided as input to the additional machine learning model, the information corresponding to the task performance. The instructions may also cause the system to obtain the information corresponding to the task performance from one or more task management applications. The one or more patterns may be semantic connections among the metadata that are usable to generate the recommendation. Implementations of the described techniques may include hardware, a method or process, or computer software on a computer-accessible medium.

One general aspect includes one or more non-transitory computer-readable storage media storing computer-executable instructions that, if executed by one or more processors of a computer system, may cause the computer system to extract metadata from information stored in one or more data sources, the information usable in performance of a task. The instructions may also cause the computer system to pass the metadata through a machine learning model that is to identify one or more patterns within the metadata indicative of lower than a threshold efficiency of the performance of the task. The instructions may also cause the computer system to obtain, from the machine learning model, a recommendation to set a task parameter. The instructions may also cause the computer system to provide the recommendation to one or more client devices as a performance indicator. The instructions may also cause the computer system to, responsive to receiving a selection of the performance indicator from at least one of the one or more client devices, set the task parameter. Other embodiments of this aspect include corresponding computer systems, apparatus, and computer programs recorded on one or more computer storage devices, each configured to perform the actions of the methods.

Implementations may include one or more of the following features. The task parameter may be set to increase the efficiency of the performance of the task to be greater than the threshold efficiency. The instructions may also cause the computer system to provide the task parameter to a task management platform communicatively coupled to the one or more data sources. The instructions may also cause the computer system to extract additional metadata from additional information stored in the one or more data sources, the additional information usable in the performance of the task. The instructions may also cause the computer system to pass the additional metadata through the machine learning model to obtain one or more additional recommendations. The performance indicator may be updated in real-time responsive to extracted metadata being periodically passed through the machine learning model. The performance indicator may indicate lower than the threshold efficiency of the performance of the task. The machine learning model may be a large language model implementing natural language processing. Implementations of the described techniques may include hardware, a method or process, or computer software on a computer-accessible medium.

The specification and drawings are to be regarded in an illustrative rather than a restrictive sense. It will, however, be evident that various modifications and changes may be made thereunto without departing from the broader spirit and scope of the invention as set forth in the claims. That is, the described embodiments are susceptible to various modifications and alternative forms, and specific examples thereof have been shown by way of example in the drawings and are herein described in detail.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.” Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors-for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

1. A computer-implemented method performed by a task managing system, the computer-implemented method comprising:
periodically extracting, from data obtained from one or more task management applications, metadata corresponding to a task, the metadata including information corresponding to task execution of the task;
providing the metadata as input to a large language model implementing natural language processing, the large language model trained using information including at least one of group morale, group feedback, demand shifts, and task performance metrics, and configured, based on the training, to identify one or more semantic connections among the metadata indicative of resource misallocation caused by one or more values of one or more task parameters of the one or more task management applications;
obtaining, as output from the large language model, a recommendation to adjust a task parameter of the one or more task management applications, the recommendation based, at least in part, on an identified pattern of semantic connections in the metadata indicating:
a resource misallocation caused by a value of the task parameter; and
an effect of the resource misallocation on efficiency of the task execution;
providing the recommendation to a client device designated for task management and communicatively coupled to the task managing system to cause the client device to adaptively update, as the metadata is periodically extracted and passed through the large language model, an indication on a display of the client device to indicate:
a severity of the resource misallocation;
lower than a threshold efficiency of the task execution; and
the recommendation to adjust the task parameter, the adjustment determined to address the resource misallocation; and
responsive to receiving, from the client device designated for task management, a user selection confirming the recommendation, calling an application programming interface (API) of the task managing system to adjust the task parameter, for the one or more task management applications, to increase the efficiency of the task execution to greater than the threshold efficiency by addressing the resource misallocation.

2. The computer-implemented method of claim 1, wherein the information corresponding to the task execution comprises one or more indicators of group morale, group feedback, and/or demand shifts.

3. The computer-implemented method of claim 1, further comprising confirming that the adjusted task parameter improves the efficiency of the task execution by:
extracting, from further data obtained from the one or more task management applications, updated metadata corresponding to the task;
providing the updated metadata as input to the large language model; and
obtaining, as output from the large language model, a recommendation to maintain the adjusted task parameter based, at least in part, on the updated metadata.

4. (canceled)

5. The computer-implemented method of claim 1, wherein the indication is adaptively updated as additional patterns of semantic connections are identified by the large language model.

6. The computer-implemented method of claim 1, wherein calling the API of the task managing system comprises invoking a function exposed by the API to adjust the task parameter.

7. The computer-implemented method of claim 1, wherein the recommendation comprises a textual recommendation for mitigating the effect of the resource misallocation on the efficiency of the task execution via the adjustment of the task parameter.

8. A system, comprising:
one or more processors; and
one or more non-transitory computer-readable media comprising computer-executable instructions recorded thereon that, if executed by the one or more processors, cause the system to:
periodically extract metadata from information, shared among a plurality of client devices, corresponding to performance of a task, the information usable by one or more task management applications during the performance of the task;
provide the metadata as input to a large language model implementing natural language processing, the large language model trained using information including at least one of group morale, group feedback, demand shifts, and task performance metrics, and configured, based on the training, to identify one or more semantic connections among the metadata indicative of use of a task parameter that is lowering an efficiency of the performance of the task to lower than a threshold efficiency;
obtain, as output from the large language model, a recommendation to update the task parameter based, at least in part, on an identified pattern of semantic connections in the metadata;
present, from a display of a first client device designated for task management, an indication that is adaptively updated based, at least in part, on the metadata periodically extracted from the information corresponding to the performance of the task, the indication indicating the recommendation to update the task parameter; and
responsive to receiving, from the first client device designated for task management, a selection of the indication confirming the recommendation, call an application programming interface (API) of the system to update the task parameter, for the one or more task management applications, according to the recommendation to increase the efficiency of the performance of the task to greater than the threshold efficiency.

9. The system of claim 8, wherein the metadata is dynamically identified and passed through the large language model so as to generate recommendations to update task parameters to increase the efficiency of the performance of the task.

10. The system of claim 8, wherein the indication is presented immediately upon obtaining the recommendation as output from the large language model.

11. The system of claim 8, wherein the selection of the indication corresponds to approval, via the first client device, of updating the task parameter to output an updated task parameter to be communicated to remaining client devices of the plurality of client devices.

12. The system of claim 8, wherein the computer-executable instructions include further instructions that cause the system to further cause an additional machine learning model to select, from information provided as input to the additional machine learning model, the information corresponding to the performance of the task.

13. The system of claim 8, wherein the computer-executable instructions include further instructions that further cause the system to obtain the information corresponding to the performance of the task from one or more task management applications.

14. The system of claim 8, wherein the computer-executable instructions include further instructions that further cause the system to communicate the updated task parameter to remaining client devices of the plurality of client devices to cause the plurality of client devices to collectively perform the task based, at least in part, on the updated task parameter.

15. One or more non-transitory computer-readable storage media storing computer-executable instructions that, if executed by one or more processors of a computer system, cause the computer system to at least:
periodically extract metadata from information obtained from one or more task management applications, the information usable in performance of a task;
pass the metadata through a large language model implementing natural language processing, the large language model trained using information including at least one of group morale, group feedback, demand shifts, and task performance metrics, and configured, based on the training, to identify one or more semantic connections among the metadata indicative of lower than a threshold efficiency of the performance of the task caused by one or more values of one or more task parameters of the one or more task management applications;
obtain, from the large language model, a recommendation to set a task parameter of the one or more task management applications to a value determined to increase efficiency of the performance of the task to greater than the threshold efficiency;
provide, to one or more client devices including a client device designated for task management, the recommendation as a performance indicator indicating the lower than the threshold efficiency of the performance of the task and further indicating the recommendation to set the task parameter, the performance indicator adaptively updated, at a user interface of the one or more client devices, as one or more patterns of semantic connections among the metadata are identified responsive to one or more changes in the performance of the task over time; and
responsive to receiving, from the client device designated for task management, a selection of the performance indicator confirming the recommendation, call an application programming interface (API) of the computer system to set the task parameter, for the one or more task management applications, to the value determined to increase the efficiency of the performance of the task to be greater than the threshold efficiency.

16. The one or more non-transitory computer-readable storage media of claim 15, wherein the one or more client devices are communicably coupled to a task management platform implementing the one or more task management applications.

17. The one or more non-transitory computer-readable storage media of claim 15, wherein the computer-executable instructions include further instructions that further cause the computer system to at least:
extract additional metadata from additional information obtained from the one or more task management applications, the additional information usable in the performance of the task; and
pass the additional metadata through the large language model to obtain one or more additional recommendations.

18. The one or more non-transitory computer-readable storage media of claim 15, wherein the performance indicator is adaptively updated in real-time responsive to the extracted metadata being periodically passed through the large language model.

19. The one or more non-transitory computer-readable storage media of claim 15, wherein the computer-executable instructions include further instructions that further cause the computer system to at least, further responsive to receiving the selection, transmit the task parameter to the one or more client devices to cause the performance of the task, by the one or more client devices, based, at least in part, on the value determined to increase the efficiency of the performance of the task to be greater than the threshold efficiency.

20. (canceled)

21. The computer-implemented method of claim 1, further comprising causing the task to be executed, at least using one or more client devices, based, at least in part, on the adjusted task parameter.

22. The computer-implemented method of claim 1, further comprising, after adjusting the task parameter, reviewing progress of the task and performing update validation and issue flagging to determine whether performance of the task is aligned with the adjusted task parameter.
